(19) United States
(12) Patent Application Publication
(10) Pub. No.: US 2024/0059560 A1
(43) Pub. Date: Feb. 22, 2024

(54) PRODUCTION OF HYDROGEN FROM HYDROCARBONS

(71) Applicant: The Johns Hopkins University, Baltimore, MD (US)

(72) Inventors: Jonah D. Erlebacher, Chevy Chase, MD (US); Shashank Vummidi Lakshman, Baltimore, MD (US); Jonathan Luke Horlyck, Washington, DC (US); Gina Reba Greenidge, Baltimore, MD (US)

(21) Appl. No.: 18/271,003

(22) PCT Filed: Jan. 7, 2022
(86) PCT No.: PCT/US2022/011691

§ 371 Date: Jul. 5, 2023

Related U.S. Application Data
(60) Provisional application No. 63/134,796, filed on Jan. 7, 2021.

(51) Int. Cl. C01B 3/26

(52) U.S. Cl. CPC C01B 3/26; C01B 2203/1058

(57) ABSTRACT

A method of producing hydrogen includes subliming a metal salt comprising a metal and a halide to yield a gas phase metal salt comprising the metal and the halide, and contacting the gas phase metal salt with a gas phase hydrocarbon to yield the metal in elemental form, carbon in elemental form, hydrogen gas, and a hydrogen halide comprising the halide.

### CROSS-REFERENCE TO RELATED APPLICATION

This application claims the benefit of U.S. Patent Application No. 63/134,796 entitled “PRODUCTION OF HYDROGEN FROM HYDROCARBONS” and filed on Jan. 7, 2021, which is incorporated herein by reference in its entirety.

### FEDERALLY SPONSORED RESEARCH OR DEVELOPMENT

This invention was made with government support under contract DE-AR00001019 awarded by the Advanced Research Projects Administration—Energy, part of the U.S. Department of Energy. The government has certain rights in the invention.

### TECHNICAL FIELD

This invention relates to methods and systems for producing hydrogen from hydrocarbons.

### BACKGROUND

Hydrogen is typically produced by steam methane reforming or electrolysis. In steam methane reforming, natural gas is reacted with water at high temperature and pressure to yield hydrogen and carbon monoxide. Additional hydrogen can be obtained by reacting the carbon monoxide with water to yield hydrogen and carbon dioxide. In electrolysis, an electrochemical reaction is used to split water into hydrogen and oxygen. Steam methane reforming, used to produce over 95% of all hydrogen, requires large amounts of water and also produces millions of metric tons of carbon dioxide per year. Electrolysis is less cost efficient than steam methane reforming, requiring large amounts of water as well as large amounts of electrical power.

### SUMMARY

This disclosure generally relates to systems and methods for hydrogen production from hydrocarbons. Embodiments include systems and methods for reduction of a gas phase metal halide with a gas phase hydrocarbon to yield elemental carbon, a hydrogen halide and the metal, and re-oxidation of the metal with the hydrogen halide to yield hydrogen gas and the metal halide. The reduced metal halide and carbon catalyze the pyrolysis of gas phase hydrocarbons to yield additional elemental carbon and hydrogen gas.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.
Embodiment 1 is a reaction method comprising:
subliming a metal salt comprising a metal and a halide to yield a gas phase metal salt comprising the metal and the halide; and
contacting the gas phase metal salt with a gas phase hydrocarbon to yield the metal in elemental form, carbon in elemental form, hydrogen gas, and a hydrogen halide comprising the halide.
Embodiment 2 is a method of embodiment 1, wherein the contacting occurs at a temperature in a range between about 800° C. and about 1300° C. or between about 850° C. and about 1300° C.
Embodiment 3 is a method of embodiment 1 or 2, wherein the metal comprises one or more of magnesium, calcium, manganese, iron, cobalt, nickel, and copper.
Embodiment 4 is a method of any one of embodiments 1 through 3, wherein the halide comprises one or more of fluoride, chloride, bromide, and iodide.
Embodiment 5 is a method of any one of embodiments 1 through 4, wherein the gas phase hydrocarbon comprises natural gas.
Embodiment 6 is a method of any one of embodiments 1 through 5, wherein the gas phase hydrocarbon comprises one or more of methane, ethane, propane, butane, pentane, hexane, heptane, octane, and nonane or any isomer thereof.
Embodiment 7 is a method of any one of embodiments 1 through 6, wherein the subliming occurs at a pressure in a range between about 0.1 bar and about 50 bar.
Embodiment 8 is a method of any one of embodiments 1 through 7, wherein the contacting occurs at a pressure in a range between about 0.1 bar and about 50 bar.
Embodiment 9 is a method of any one of embodiments 1 through 8, further comprising pyrolyzing the gas phase hydrocarbon to yield the carbon and the hydrogen gas.
Embodiment 10 is a method embodiment 9, wherein the contacting comprises reducing the metal in the gas phase metal salt with the gas phase hydrocarbon.
Embodiment 11 is a method of embodiment 9 or 10, wherein the pyrolyzing is catalyzed by the metal.
Embodiment 12 is a method of any one of embodiments 9 through 11, wherein the heat for the pyrolyzing is provided by electrical power.
Embodiment 13 is a method of any one of embodiments 1 through 12, further comprising contacting the metal with the hydrogen halide to yield the metal salt in the gas phase and hydrogen gas.
Embodiment 14 is a method of embodiment 13, further comprising heating the hydrogen halide before contacting the metal with the hydrogen halide.
Embodiment 15 is a method of embodiment 14, wherein heating the hydrogen halide comprises heating the hydrogen halide to a temperature of at least 1000° C.
Embodiment 16 is a method of embodiment 14 or 15, wherein contacting the metal with the hot hydrogen halide to yield the metal salt occurs in an adiabatic reactor.
Embodiment 17 is a method of any one of embodiments 13 through 16, further comprising condensing the metal salt to yield the metal salt in the solid phase.
Embodiment 18 is a method of embodiment 17, wherein the metal salt in the solid phase is in the form of particles, and the particles are at least partially coated with the carbon.
Embodiment 19 is a method of embodiment 18, further comprising contacting the metal salt with hydrogen chloride having a temperature of at least 1000° C. to yield the metal halide in the gas phase and a particulate carbon material.
Embodiment 20 is a method of embodiment 19, wherein the particulate carbon material comprises a multiplicity of hollow carbon particles.
Embodiment 21 is a method of embodiment 20, wherein the hollow carbon particles have a diameter in a range of about 200 nm to about 300 nm.
Embodiment 22 is a method of embodiment 21, wherein the particulate carbon material comprises less than 100 parts per million by weight of the metal.
Embodiment 23 is a method of any one of embodiments 1 through 22, wherein the halide is chloride and the metal is nickel.
Embodiment 24 is a method of any one of embodiments 1 through 23, wherein the hydrocarbon comprises methane.
Embodiment 25 is a method of any one of embodiments 1 through 24, wherein the subliming occurs prior to the contacting.
Embodiment 26 is a method of any one of embodiments 1 through 25, wherein the subliming comprises advancing the metal salt toward a reaction zone of a reactor with the gas phase hydrocarbon.
Embodiment 27 is a method of embodiment 26, further comprising heating the reaction zone to a temperature in range between about 800° C. and about 1300° C.
Embodiment 28 is a method of embodiment 26 or 27, wherein heating the reaction zone is achieved with electrical power.
Embodiment 29 is a method of embodiment 28, wherein the electrical power is used to generate radiant heat.
Embodiment 30 is a method of embodiment 29, wherein the radiant heat is provided by an electric furnace or inductive heating elements.
Embodiment 31 is a method of any one of embodiments 1 through 30, wherein the subliming and the contacting occur simultaneously in the reaction zone of the reactor.
Embodiment 32 is a method of any one of embodiments 1 through 31, wherein the metal salt is anhydrous.
Embodiment 33 is a method of generating hydrogen gas, the method comprising:
contacting a metal halide in the gas phase with a hydrocarbon in the gas phase;
decomposing the metal halide and the hydrocarbon to yield a gaseous product comprising hydrogen and hydrogen halide and a solid product comprising metal and carbon;
separating the hydrogen from the hydrogen halide; and
contacting the hydrogen halide with the metal to yield the metal halide in the gas phase.
Embodiment 34 is a method of embodiment 33, further comprising, after contacting the hydrogen halide with the metal, cooling the metal halide in the gas phase to yield the metal halide in the solid phase.
Embodiment 35 is a method of embodiment 34, further comprising heating the metal halide in the solid phase to yield the metal halide in the gas phase.
Embodiment 36 is a method of embodiment 35, further comprising contacting the metal halide in the gas phase with the hydrocarbon in the gas phase.
Embodiment 37 is a method of any one of embodiments 33 through 36, further comprising separating the gaseous product from the solid product.
Embodiment 38 is a method of any one of embodiments 33 through 37, further comprising, before contacting the hydrogen halide with the metal, heating the hydrogen halide to a temperature of at least about 1000° C.
Embodiment 39 is a method of any one of embodiments 33 through 38, further comprising contacting the solid product with the hydrogen halide to yield the metal halide in the gas phase and the carbon.
Embodiment 40 is a method of embodiment 39, further comprising condensing the metal halide to yield a solid mixture comprising metal halide and the carbon.
Embodiment 41 is a method of embodiment 40, wherein the solid mixture comprised particles of the metal halide coated with some of the carbon.
Embodiment 42 is a method of embodiment 41, further comprising contacting the solid mixture with hydrogen chloride having a temperature of at least 1000° C. to yield the metal halide in the gas phase and a particulate carbon material.
Embodiment 43 is method of embodiment 42, wherein the particulate carbon material comprises a multiplicity of hollow carbon particles.
Embodiment 44 is a method of embodiment 43, wherein the hollow carbon particles have a diameter in a range of about 200 nm to about 300 nm.
Embodiment 45 is a method of embodiment 44, wherein the particulate carbon material comprises less than 100 parts per million by weight of the metal.
Embodiment 46 is a hydrogen production system comprising:
a first reactor configured react gaseous reactants;
a heat exchanger configured to receive a mixture of gaseous and solid reaction products from the first reactor;
a separator configured to receive a gaseous output from the heat exchanger and to provide a gaseous input to the heat exchanger;
a second reactor configured to react a solid input and a gaseous input from the heat exchanger;
a cooler configured to condense a reaction product from the second reactor;
a third reactor configured to receive a solid product from the cooler, evaporate the solid product to yield a gaseous product, and provide the gaseous product to the first reactor.
Embodiment 47 is a system of embodiment 46, wherein the first reactor, the second reactor, or both are configured to operate at a temperature in a range between about 800° C. and about 1200° C.
Embodiment 48 is a system of embodiment 46 or 47, wherein the second reactor is an adiabatic reactor.
Embodiment 49 is a system of any one of embodiments 46 through 48, wherein the third reactor is configured to separate components of the solid product from the cooler.
Embodiment 50 is a system of any one of embodiments 46 through 49, further comprising an additional separator configured to remove hydrogen from the gaseous input from the heat exchanger.

Systems and methods described herein are advantageously more energy efficient than steam methane reforming and much more energy efficient than electrolysis. These systems and methods can be powered using electricity, do not include water as a reactant, do not produce carbon dioxide as a product, and produce a highly pure carbon by-product. In addition, these systems and methods produce a free-flowing elemental carbon powder, without the buildup of carbon tar products on hot pyrolysis reactor surfaces.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a flowchart depicting a reaction scheme for the sublimation of a metal salt, reaction of the gas phase metal salt with a hydrocarbon, and pyrolysis of the hydrocarbon to yield hydrogen gas.

FIG. 2 is a schematic view of a reactor configured to implement the reactions depicted in FIG. 1.

FIG. 3 shows methane decomposition as a function of temperature in a reactor similar to that depicted in FIG. 2.

FIG. 4A is an image of nickel chloride before sublimation in the reaction scheme of FIG. 1. FIGS. 4B and 4C are images of the nickel chloride after partial consumption in the reaction scheme of FIG. 1.

FIG. 5 is a flowchart depicting a reaction scheme for the oxidation of the metal generated in the reaction scheme of FIG. 1 with a concentrated hydrogen halide to yield hydrogen gas and the metal salt of FIG. 1.

FIG. 6 is a flow chart showing operations in the production of hydrogen gas according to embodiments described herein.

FIG. 7 is an exemplary process flow diagram for the production of hydrogen gas according to embodiments described herein.

FIG. 8 is a schematic view of a unit for separating nickel chloride and carbon solids, and evaporating the nickel chloride.

FIG. 9A is a transmission electron micrograph image of nickel particles coated with carbon before regeneration and evaporation of nickel chloride in heater. FIG. 9B is a transmission electron micrograph of hollow carbon particles produced after regeneration and evaporation of nickel chloride from the material in FIG. 9A. FIGS. 9C and 9D are scanning electron microscope micrographs at 10,000× and 50,000×, respectively, of hollow carbon particles produced after regeneration and evaporation of nickel chloride from the material in FIG. 9A.

### DETAILED DESCRIPTION

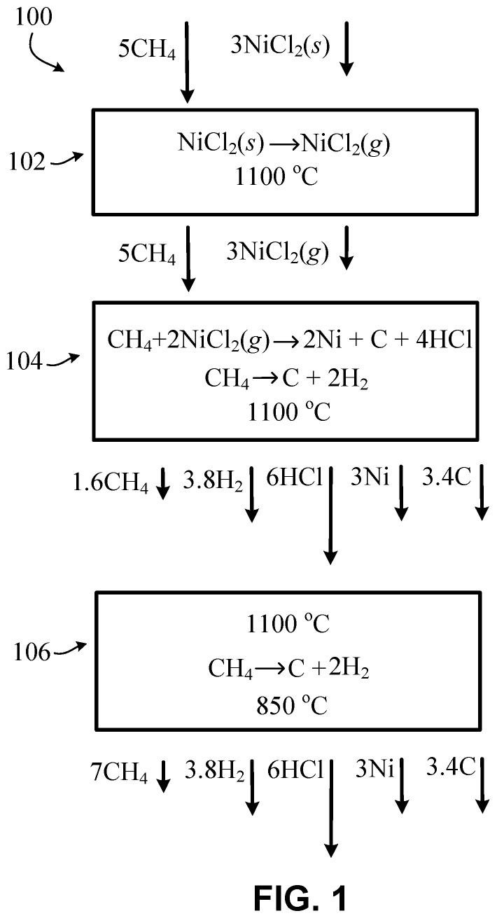

FIG. 1 is a flowchart depicting reaction scheme 100 for the sublimation of a metal salt, reaction of the gas phase metal salt with a gas phase hydrocarbon, and pyrolysis of the hydrocarbon to yield hydrogen gas. In the example depicted in FIG. 1, the metal salt is nickel chloride and the gas phase hydrocarbon is methane. However, in some implementations, the metal includes one or more alkali-earth metals and transition metals such as magnesium, calcium, manganese, iron, cobalt, nickel, and copper, and the metal salt is a metal halide that includes one or more of fluoride, chloride, bromide, and iodide. In certain implementations, the gas phase hydrocarbon includes one or more of methane, ethane, propane, butane, pentane, hexane, heptane, octane, and nonane or any isomer thereof. In some implementations, the gas phase hydrocarbon includes natural gas.

In reaction 102, the metal salt is sublimed to yield a gas phase metal salt. The metal salt is typically a metal halide in the form of an anhydrous powder. Reaction 102 is endothermic and occurs under temperature and pressure conditions selected to sublimate the metal salt. In reaction 104, the gas phase metal salt reacts with a gas phase hydrocarbon to yield the metal in elemental form, carbon in elemental form, and a gas phase hydrogen halide. In some cases, reaction 102 is initiated by blowing the metal salt toward a heated reaction zone in a reactor with the gas phase hydrocarbon. Metal chloride reduction in reaction 104 is exothermic and occurs in the absence of a catalyst under temperature and pressure conditions selected such that contacting the gas phase metal salt with the gas phase hydrocarbon reduces the metal in the metal salt and decomposes the hydrocarbon. In some implementations, reaction 102 occurs before reaction 104. In some implementations, reaction 102 and reaction 104 occur concurrently. In some implementations, reaction 106 occurs concurrently with reactions 102 and 104. In reaction 106, which in one implementation occurs in the absence of the metal salt (i.e., after the metal salt has been consumed in reaction 104, with excess hydrocarbon present), the hydrocarbon is decomposed to yield elemental carbon and hydrogen gas. Reaction 106 by itself is endothermic and occurs under temperature and pressure conditions selected to pyrolyze the hydrocarbon in the presence of the metal and carbon in elemental form, which can serve as a catalyst. Reaction 106 will proceed until the reactants have cooled to a temperature such that pyrolysis is kinetically stopped, typically around 850° C.

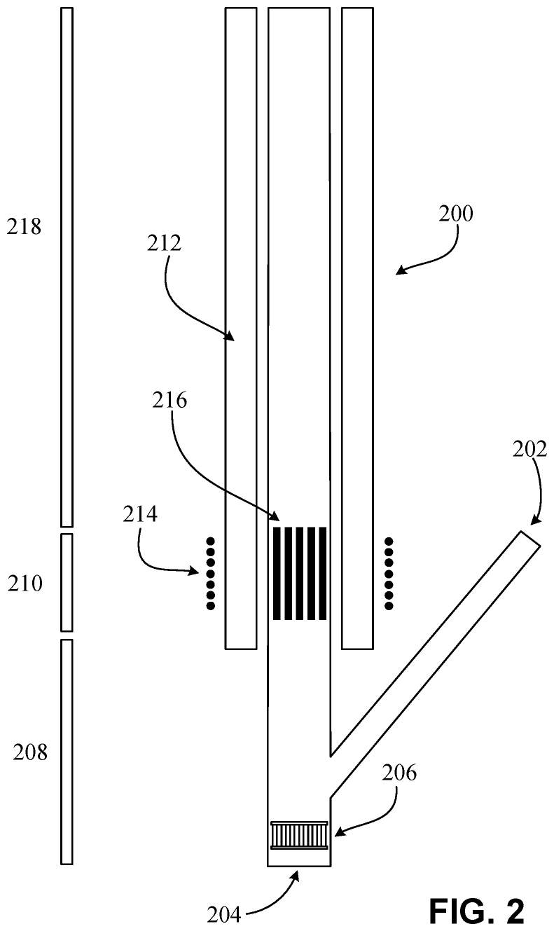

FIG. 2 depicts a portion of a reactor 200 configured to conduct reactions 102, 104, and 106 of reaction scheme 100. Metal salt is provided (e.g., in anhydrous powder form) to reactor 200 through inlet 202. Gas phase hydrocarbon is provided to reactor 200 through inlet 204, and passes through distributor 206. The gas phase hydrocarbon can be mixed with an inert gas (e.g., argon). The gas phase hydrocarbon contacts the metal salt in mixing zone 208, and the mixture is advanced to reaction zone 210. In one example, reaction zone 210 includes a fluidized bed. Electrical power is used to generate radiant heat in reaction zone 210, for example, with an electric furnace or radiofrequency induction heating. Reaction zone 210 can be maintained at a temperature in a range between about 800° C. and about 1300° C. and an appropriate corresponding pressure selected for completion of reactions 102 and 104. In some implementations, reactor 200 includes insulation 212. As depicted in FIG. 2, reaction zone 210 includes radiofrequency coils 214 and heating elements 216. Reactions 102 and 104 can occur concurrently in reaction zone 210. Reaction 106 occurs in exit zone 218. Pyrolysis of the hydrocarbon in exit zone 218 typically occurs at a temperature in a range between about 800° C. and about 1300° C. (e.g., between about 850° C. and about 1300° C., or about 850° C. or greater) and an appropriate corresponding pressure selected for complete pyrolysis of the available hydrocarbon. Pyrolysis leads to cooling of the reaction products in exit zone 218. In some implementations, the reaction products exit reactor at about 850° C.

By way of example, as depicted in FIG. 1, the metal salt is anhydrous nickel chloride in the form of a powder and the hydrocarbon is methane. Reaction 102 is conducted under temperature and pressure conditions selected to sublimate the nickel chloride (e.g., between about 750° C. and about 1300° C., or about 1100° C., and an appropriate corresponding pressure in a range between about 0.1 bar and about 50 bar). Reaction 102 is endothermic and requires an energy input of about 213 kJ per mole of methane when the reactants have been preheated to 400° C. In reaction 104, methane reacts with the gas phase nickel chloride at a temperature in a range between about 800° C. and about 1300° C. (e.g., between about 850° C. and about 1300° C., or about 1100° C.) to yield nickel, carbon, and hydrogen chloride. Reaction 104 can be conducted at an appropriate corresponding pressure in a range between about 0.1 bar and about 50 bar. Reaction 104 is slightly exothermic and has an energy output of about 6 kJ per mole of methane provided to reaction 104. In reaction 106, unreacted methane is pyrolyzed to yield carbon and hydrogen gas. Reaction 106 is endothermic and cools the product stream from 1100° C. to 850° C. In some implementations, reduction of the nickel in reaction 104 and pyrolysis of the methane in reaction 106 occur concurrently.

For the example depicted in FIG. 1, when reaction 102 occurs prior to reaction 104, 0.5 mole of methane is decomposed in reaction 104 per mole of nickel chloride, and 1.2 mole of methane is decomposed in reaction 106 per mole of nickel chloride, yielding a 5:3 molar ratio of methane to nickel chloride.

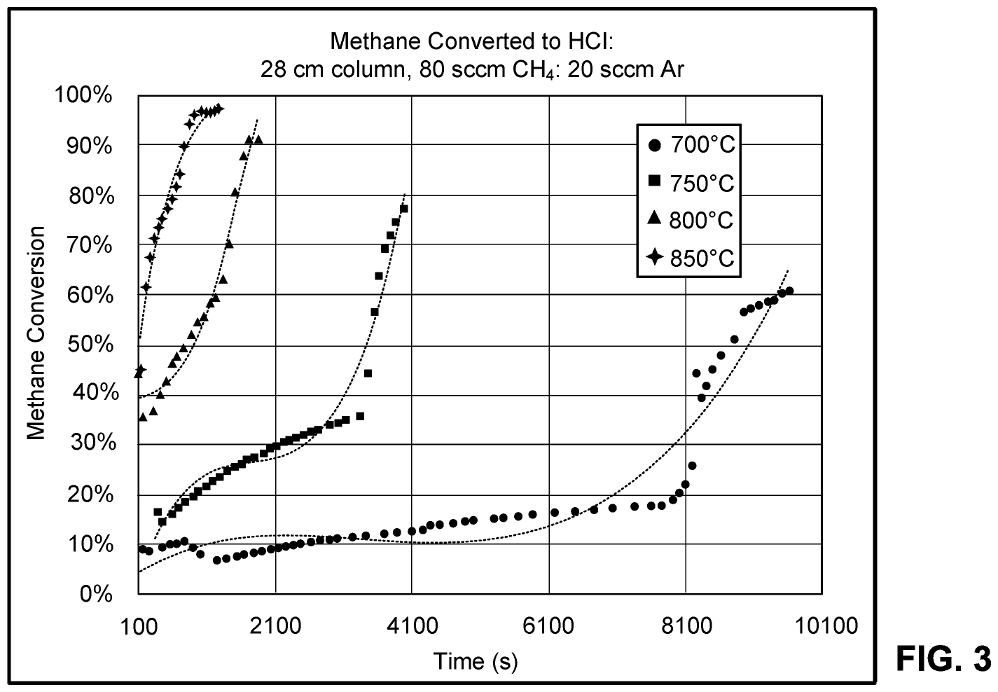

FIG. 3 shows methane decomposition by reduction of nickel chloride as a function of temperature according to the nickel chloride reduction reaction 104 in a reactor similar to that described with respect to FIG. 2, but packed with a plug of unmoving nickel chloride. The column length of the reactor was 28 cm, and the ratio of methane to argon (standard cubic centimeters per minute) was 80:20. As seen in FIG. 3, the initial conversion of methane to hydrogen chloride is temperature dependent. Percent conversion rises until about one-half of the nickel chloride is consumed. At about 850° C. and greater, conversion of methane to hydrochloric acid is substantially complete (e.g., about 100%). Conversion does not decay when the nickel chloride is consumed (i.e., when the reactor volume is substantially empty). In other experiments, reaction 104 is seen to proceed at a rate of about ten times the rate of reaction 106.

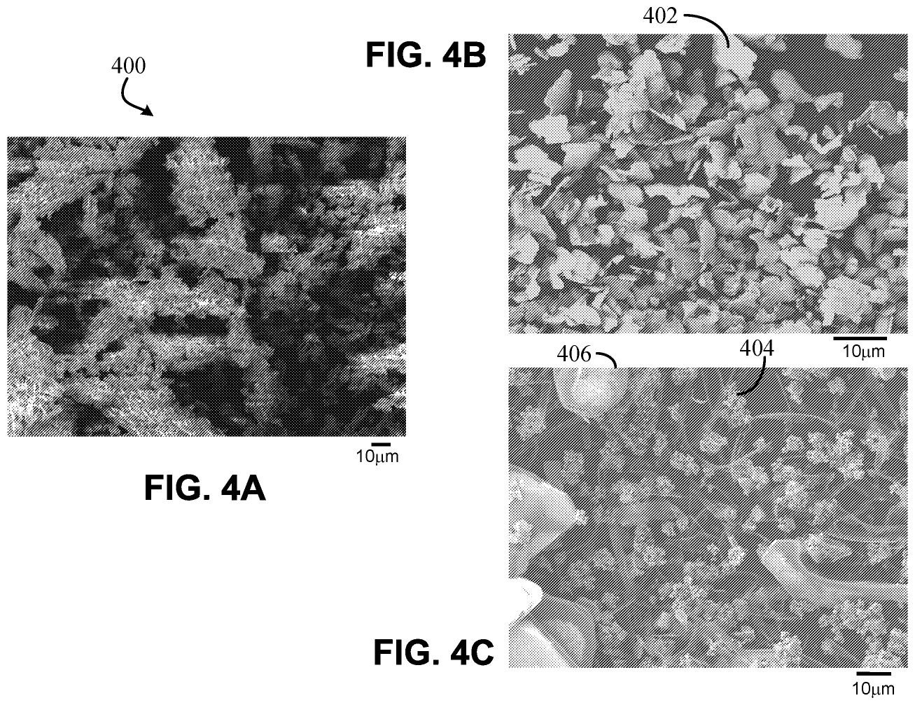

FIG. 4A is a scanning electron microscope (SEM) image of anhydrous nickel chloride powder 400 before sublimation in reaction 102. FIGS. 4B and 4C are low and high magnification SEM images, respectively, of nickel chloride about half consumed in reaction 104. FIG. 4B shows nickel chloride flakes 402, and FIG. 4C shows elemental nickel particles 404 and elemental carbon flakes 406.

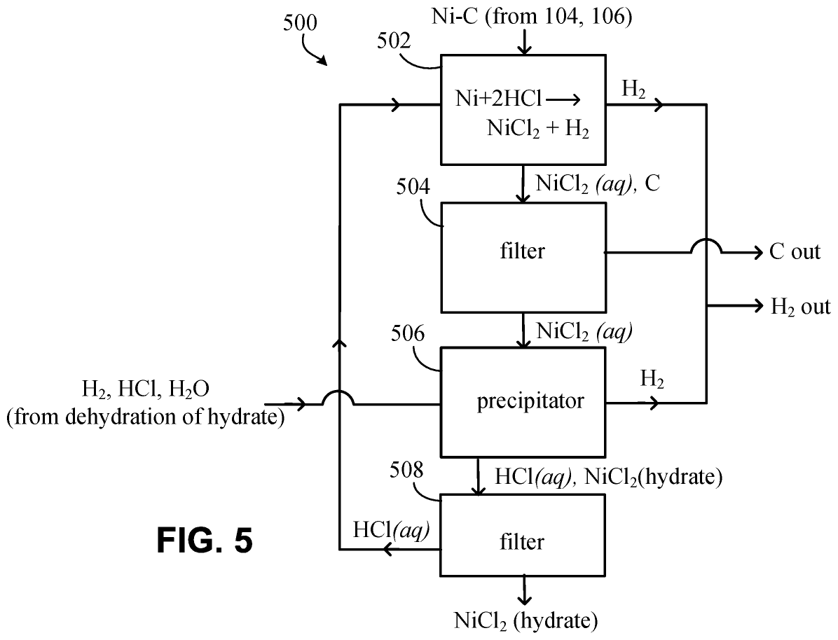

FIG. 5 is a flowchart depicting reaction scheme 500 for the oxidation of the metal generated in reaction 104 of FIG. 1 with a concentrated hydrogen halide to yield hydrogen gas and the metal salt of FIG. 1. Reaction scheme 500 typically occurs in solution. Examples of suitable solvents include water, alcohols (e.g., methanol, ethanol), other organic and inorganic solvents (e.g., dimethyl sulfoxide, thionyl chloride), or any mixture thereof. As with FIG. 1, the metal salt is nickel chloride and the halide is chloride. However, other metals and halides described with respect to FIG. 1 can also be selected to undergo reactions corresponding to those in FIG. 5.

In reaction scheme 500, the metal and carbon solids from reactions 104 and carbon solids from reaction 106, if present, are combined with a mixture including a solvent and the hydrogen halide from reaction 104. In some implementations, the products of reaction 104 and 106 are cooled (e.g., to a temperature in a range between about 25° C. and about 200° C.) before contacting the hydrogen halide and solvent at a corresponding appropriate pressure (e.g., a pressure in a range between about 0.1 bar and about 20 bar) to initiate reaction 502. In one implementation, the metal and carbon solids are provided to a heated mixture including the solvent and the hydrogen halide. The hydrogen halide and the metal react to yield hydrogen gas and the metal salt dissolved in the solvent, which can be substantially depleted of hydrogen halide upon completion of the reaction. Generally, carbon does not react with hydrogen halide acids, and can be filtered off and removed in reaction zone 504. In some implementations, the metal salt can be recovered from the solvent by precipitation, which occurs when re-acidifying the solution in zone 506 with the gaseous products of reaction 104. The precipitated metal salt is removed from the solvent by filtration in zone 508. The metal salt, which is typically solvated, can be contacted with gases from reactions 104 and 106 to yield the anhydrous metal salt, gas phase hydrogen halide, and vaporized water, along with hydrogen. The anhydrous metal salt can be provided as a reactant for reaction 102 in reaction scheme 100, and the gases can be provided to reaction zone 506. Hydrogen gas can be collected from reaction 502 and from reaction 106 (through zone 506).

In the example depicted in FIG. 5, nickel and carbon solids from reactions 104 and 106 and gas phase hydrochloric acid from reaction 104 are combined in solution to yield nickel chloride and hydrogen gas, along with carbon solids, according to reaction 502. The nickel and the gas phase hydrochloric acid are typically cooled to a temperature in a range between about 25° C. and about 200° C. before reaction 502 is initiated. In 504, the carbon solids are filtered from the product mixture of reaction 502. In 506, nickel chloride hydrate is precipitated by acidifying the remaining product mixture from reaction 502 with the gaseous products of reactions 104 and 106. The nickel chloride hydrate is separated from the aqueous hydrochloric acid in 508, and the reclaimed hydrochloric acid can be provided to reaction 502. The nickel chloride hydrate can be dried by contacting the hydrate with gas from reactions 104 and 106 (hydrochloric acid and hydrogen) to yield anhydrous nickel chloride, gas phase hydrochloric acid, and vaporized water (from the hydrate), along with hydrogen. The anhydrous nickel chloride can be provided to reaction 102 of reaction scheme 100, and the gases can be provided to reaction zone 506. Hydrogen gas can be collected from reaction 502 and from reaction 106 (through zone 506).

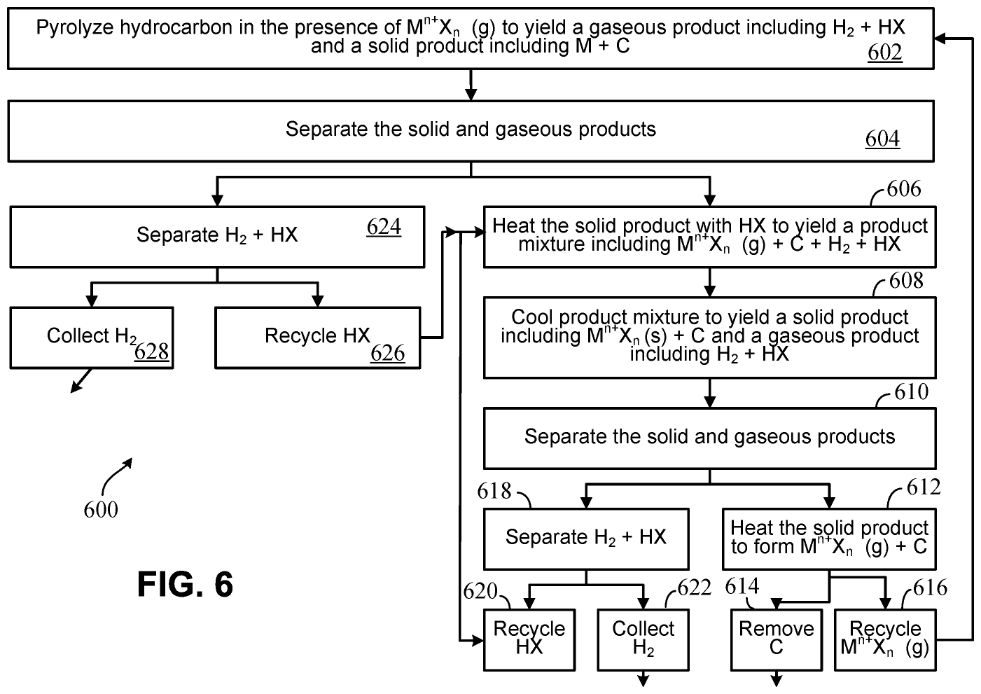

FIG. 6 is a flowchart depicting operations in an exemplary process 600 for the production of hydrogen according to embodiments described herein. In process 600, Mⁿ⁺Xₙ represents a metal halide, where M is an alkali-earth metal (e.g., magnesium or calcium) or a transition metal (e.g., manganese, iron, cobalt, nickel, or copper) and X is halogen (e.g., fluorine, chlorine, bromine, or iodine), Mⁿ⁺Xₙ is electrically neutral, and n is an integer. In certain implementations, the gas phase hydrocarbon includes one or more of methane, ethane, propane, butane, pentane, hexane, heptane, octane, and nonane or any isomer thereof. In some implementations, the gas phase hydrocarbon includes natural gas. In one example of process 600, M is nickel, X is chlorine, the hydrocarbon is methane, and n=2.

In 602, a hydrocarbon is pyrolyzed in the presence of Mⁿ⁺Xₙ (g) to yield a gaseous product and a solid product. A molar ratio of hydrocarbon to metal halide is typically in a range of about 0.5 to about 25, and residence time is typically in a range of about 0.1 seconds to about 20 seconds. The pyrolysis typically occurs in a reactor at a temperature in a range of about 1000° C. to about 1200° C. The gaseous product is a mixture including hydrogen gas (H₂) and hydrogen halide (HX), with H₂ typically in a range of about 92 mol % to about 96 mol % and HCl typically in a range of about 4% to about 8%. The solid product is a mixture including the metal (M) and carbon (C) in elemental form.

In 604, the gaseous product and the solid product are separated. In some embodiments, the products from 602 are cooled before separation in 604. In one example, the products are provided to a heat exchanger (e.g., a recuperative heat exchanger), where heat from the products is transferred to another stream (e.g., HX) in process 600.

In 606, the solid product from 604 is reacted with HX (e.g., recycled from and/or heated by other streams in process 600, as discussed with respect to 604) to yield a product mixture. A molar ratio of HX to M is typically in a range of about 1:1 to about 100:1. The reactor can be an adiabatic reactor. The reaction typically occurs in a reactor at a temperature in a range between about 900° C. and about 1200° C. In some cases, the HX includes a small amount of H₂ (e.g., less than about 5 mol %, or less than about 3 mol %), such that the product includes H₂+HX+Mⁿ⁺Xₙ (g)+C, with the total amount of H₂+HX including up to 4 mol % H₂ and at least 95 mol % HX. In certain cases, the small amount of H₂ is stripped from the HX, such that the HX is substantially pure (>99 mol % or >99.9 mol % pure) before the solid product from 604 is reacted with the HX.

In 608, the product mixture from 606 is cooled to yield a solid product including a mixture of Mⁿ⁺Xₙ (s)+C and a gaseous product including a mixture of H₂+HX, with the total amount of H₂+HX including up to 4% H₂ and at least 95 mol % HX. The cooling can be achieved in a flash cooler in which the gas stream is injected into a vessel at lower pressure, decreasing its temperature. Cooling can also be achieved using a heat exchanger. In some cases, the solid product is separated in 608 to yield a stream of Mⁿ⁺Xₙ (s) and a stream of C. That is, further downstream processing (e.g., in 612-616) is not needed to separate Mⁿ⁺Xₙ and C. In 610, the solid and gaseous products from 608 are separated. In one embodiment, separation is achieved with a ceramic candle filter.

In 612, the solid product from 610 is heated in a furnace to evaporate Mⁿ⁺Xₙ (s), thereby yielding a mixture including Mⁿ⁺Xₙ (g)+C. In 614, C is removed from the mixture of 612. In 616, Mⁿ⁺Xₙ (g) from the mixture of 612 is recycled to 602.

In 618, HX and H₂ from 610 are separated to yield a HX stream and a H₂ product stream. In one example, HX and H₂ are separated by contacting the gaseous mixture with aqueous HX to capture the HX, leaving substantially pure H₂ (e.g., >99% or >99.9% pure) as the primary hydrogen product stream. In 620, the HX stream from 618 is provided to 606. In 622, the H₂ product stream from 618 exits process 600 as substantially pure hydrogen (e.g., >99 mol % or >99.9 mol % pure).

In 624, HX and H₂ from 604 are separated to yield a HX stream and a H₂ product stream. In 626, HX from 624 is provided to 606. In 628, the H₂ product from 624 exits process 600.

In some embodiments, operations can be added to or omitted from process 600. In some embodiments, the order of operations in process 600 can be altered. In one example, the solid product is separated in 608 or 610 to yield a stream of Mⁿ⁺Xₙ (s) and a stream of C. That is, further downstream processing (e.g., in 612-616) is not needed to separate Mⁿ⁺Xₙ and C, and Mⁿ⁺Xₙ and C are separated as solids before Mⁿ⁺Xₙ is evaporated.

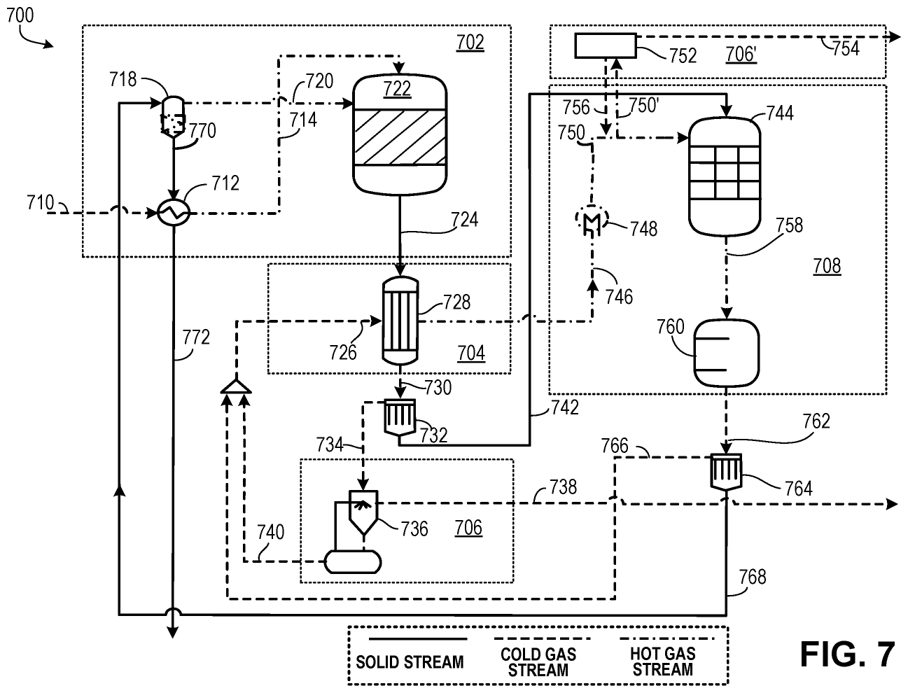

FIG. 7 is a process flow diagram depicting an exemplary system 700 for implementation of hydrogen production according to process 600, for a molar ratio of methane and metal halide of about 0.5:1 to about 25:1. In the example described with respect to FIG. 7, the metal halide is nickel chloride and the gas phase hydrocarbon is methane (or natural gas). However, as discussed with respect to process 600, other metal halides and hydrocarbons can be used in systems similar to system 700. System 700 includes hydrocarbon decomposition zone 702, heat exchange zone 704, H₂ separation zones 706, 706′, and metal halide reclamation zone 708, described in more detail below. In FIG. 7, solid streams are indicated with solid lines. Unheated (or “cold”) streams are indicated with dotted lines. Heated (or “hot”) streams are indicated with dot-dash lines.

Stream 710 (CH₄) is provided to heater 712 to yield stream 714 (CH₄). Stream 716 (NiCl₂ (s)) is provided to heater 718 to yield stream 720 (NiCl₂ (g)). Streams 714 (CH₄) and 720 (NiCl₂ (s)) are provided to reactor 722 at a CH₄:NiCl₂ molar ratio in a range of about 10:1 to about 20:1 (e.g., about 13:1 to about 17:1 or about 14:1 to about 16:1). Gas phase exothermic reduction of Ni′ and endothermic pyrolysis of CH₄, as shown in Equations 1 and 2, occur in reactor 722.

CH₄+2NiCl₂ (g)→2Ni+C+4HCl ΔH°=−147 kJ/mol CH₄ (1)

CH₄→C+2H₂ ΔH°=75 kJ/mol CH₄ (2)

Table 1 lists CH₄:NiCl₂ molar ratio and CH₄ conversion to carbon according to Equations 1 and 2 for Examples 1-19. The CH₄:NiCl₂ molar ratios range from about 1 to about 20, with CH₄ conversion in a range from about 10% to about 100% for residence times ranging from about 5 seconds to about 20 seconds. The residence time for Example 19 (95 mol % conversion, 6.08 CH₄:NiCl₂ mol ratio) was about 16 seconds. The residence time for Example 13 (88% conversion, 15.43 CH₄:NiCl₂ mol ratio) was about 8 seconds.

TABLE 1
Reactants and conversion ratio for pyrolysis of methane in Examples 1-19

| | | | CH₄ | CH₄ | NiCl₂ | NiCl₂ | CH₄:NiCl₂ | Residence | Overall |
|---|---|---|---|---|---|---|---|---|---|
| Ex. | T (° C.) | P (psig) | (L/min) | (mol/min) | (g/min) | (mol/min) | mol ratio | time (s) | Conv (%) |
| 1 | 950 | 0.18 | 1.00 | 0.04 | 0.42 | 0.0032 | 13.78 | 19.90 | 11.40 |
| 2 | 950 | 0.137 | 0.54 | 0.02 | 0.42 | 0.0032 | 7.44 | 36.85 | 25.04 |
| 3 | 950 | 0.1 | 0.26 | 0.01 | 0.42 | 0.0032 | 3.58 | 76.53 | 35.40 |
| 4 | 1000 | 0.2 | 1.00 | 0.04 | 0.75 | 0.0058 | 7.71 | 19.12 | 32.20 |
| 5 | 1000 | 0.31 | 1.50 | 0.07 | 0.64 | 0.0049 | 13.56 | 12.74 | 28.92 |
| 6 | 1000 | 0.38 | 2.00 | 0.09 | 0.64 | 0.0049 | 18.08 | 9.56 | 24.41 |
| 7 | 1000 | 0.58 | 0.53 | 0.02 | 0.68 | 0.0052 | 4.51 | 36.07 | 51.35 |
| 8 | 1000 | 1.01 | 1.00 | 0.04 | 0.68 | 0.0052 | 8.51 | 19.12 | 37.05 |
| 9 | 1000 | 0.98 | 1.50 | 0.07 | 0.68 | 0.0052 | 12.76 | 12.74 | 30.86 |
| 10 | 1100 | 0.5 | 1.50 | 0.07 | 0.77 | 0.0059 | 11.27 | 11.82 | 65.22 |
| 11 | 1100 | 0.86 | 2.00 | 0.09 | 0.77 | 0.0059 | 15.03 | 8.86 | 54.33 |
| 12 | 1100 | 0.23 | 1.00 | 0.04 | 0.75 | 0.0058 | 7.71 | 17.72 | 69.67 |
| 13 | 1200 | 0.68 | 2.00 | 0.09 | 0.75 | 0.0058 | 15.43 | 8.26 | 87.99 |
| 14 | 975 | 0.3 | 0.42 | 0.02 | 1.35 | 0.0104 | 1.80 | 46.43 | 63.00 |
| 15 | 975 | 0.4 | 1.00 | 0.04 | 0.62 | 0.0048 | 9.33 | 19.50 | 20.00 |
| 16 | 1100 | 0.4 | 0.52 | 0.02 | 3.00 | 0.0231 | 1.00 | 34.08 | 99.80 |
| 17 | 1100 | 0.39 | 2.00 | 0.09 | 1.91 | 0.0147 | 6.06 | 8.86 | 58.00 |
| 18 | 1100 | 0.88 | 2.50 | 0.11 | 1.91 | 0.0147 | 7.57 | 7.09 | 54.50 |
| 19 | 1200 | 0.41 | 1.05 | 0.05 | 1.00 | 0.0077 | 6.08 | 15.73 | 95.00 |

From reactor 722, stream 724 (H₂+HCl+Ni+C) is provided to heat exchange zone 704, where stream 724 is cooled by stream 726 (recycled HCl) in heat exchanger 728. Heat exchanger 728 can be a recuperative heat exchanger. In heat exchanger 728, stream 726 cools stream 724 to a temperature in a range between about 150° C. and about 250° C. (e.g., about 200° C.). In one example, heat exchanger 728 is a shell and tube exchanger, and stream 724 is provided to the tube side. Stream 730 (C+Ha+HCl+Ni) is provided to filter 732, where the gaseous products (H₂+HCl) are separated from the solid products (C+Ni). In one example, filter 732 is a candle filter.

Stream 734 (H₂+HCl) is provided to separator 736 in H₂ separation zone 706 to yield stream 738 (H₂) and stream 740 (HCl). In one example, separator 736 operates by spraying stream 734 with aqueous HCl (e.g., 20 wt % HCl at 25° C.) to capture the HCl from stream 734. Stream 738 (substantially pure H₂) exits system 700 from separator 736. Stream 740 (aqueous HCl) can be distilled (e.g., by pressure swing distillation) to produce anhydrous HCl. Stream 738 (>99.9 mol % pure) is the primary hydrogen product stream. Stream 740 (HCl) is returned to heat exchanger 728 in stream 726.

From filter 732, stream 742 (Ni+C) is provided to reactor 744 in metal halide reclamation zone 708. Reactor 744 can be an adiabatic reactor or a heated reactor. The Ni and C solids typically have a particle diameter in a range of about 0.1 μm to about 1 μm (e.g., about 0.1 μm to about 0.5 μm, or about 0.2 μm to about 0.4 μm). From heat exchanger 728, stream 746 (HCl) is provided to heater 748. Stream 746 can include a small amount (e.g., less than about 5%) of H₂. From heater 748, stream 750 (HCl) is provided to reactor 744 with a molar ratio of HCl:Ni in a range of about 5:1 to about 50:1. In reactor 744, Ni reacts with HCl to yield NiCl₂ (g), as shown in Equation 3.

Ni+2HCl→NiCl₂ (g)+H₂ ΔH°=110 kJ/mol Ni (3)

The HCl in stream 750 heats the solids from stream 742 in reactor 744 to a temperature in a range between about 1000° C. and about 1200° C. thereby driving the formation of NiCl₂ (g) in reactor 744. In one example, reactor 744 has a downflow design and is co-fed with HCl and Ni+C solids (e.g., concurrent gas-solid flow in an adiabatic reactor with hot HCl gas). A residence time in reactor 744 is typically in a range of about 5 seconds to about 30 seconds (e.g., about 10 seconds).

In some cases, stream 746 (and thus stream 750) includes a small amount (e.g., less than about 5%) of H₂. An equivalent molar quantity of chlorine gas is added to stream 750 via stream 756. The chlorine gas reacts with H₂ in stream 750 to form excess HCl gas. This excess HCl gas is removed via stream 750′, leaving 750 as a stream of pure HCl (e.g., >99 mol % pure or >99.9 mol % pure). Stream 750′ is provided to separator 752 in H₂ separation zone 706′. In some embodiments, separator 752 is a chlor-alkali electrolyzer, which produces pure hydrogen (stream 754) and chlorine (stream 756) from a stream of HCl (stream 750′). Stream 754 (>99.9 mol % H₂) exits system 700 and can be combined with primary hydrogen product stream 738 (>99.9 mol % H₂).

From reactor 744, stream 758 (H₂+HCl+NiCl₂ (g)+C) enters cooler 760, where NiCl₂ (g) is condensed to yield NiCl₂ (s). Heat from cooler 760 can be used to generate steam to power H₂ separation in one or both of H₂ separation zones 706, 706′. Stream 762 (H₂+HCl+NiCl₂ (s)+C) enters filter 764, where the solid products are separated from the gaseous products. In one example, filter 764 is a ceramic candle filter. Stream 766 (H₂+HCl) is combined with stream 740 (HCl) and recycled to heat exchanger 728 in stream 726 (HCl). Stream 768 (NiCl₂ (s)+C) is recycled to heater 718 in hydrocarbon decomposition zone 702, where NiCl₂ (s) is evaporated to yield NiCl₂ (g). Stream 770 (C) exits heater 718 as carbon solids. In some cases, heat from stream 770 is provided to heater 712 to heat stream 710, and stream 772 (C) exits system 700 as cooled carbon solids.

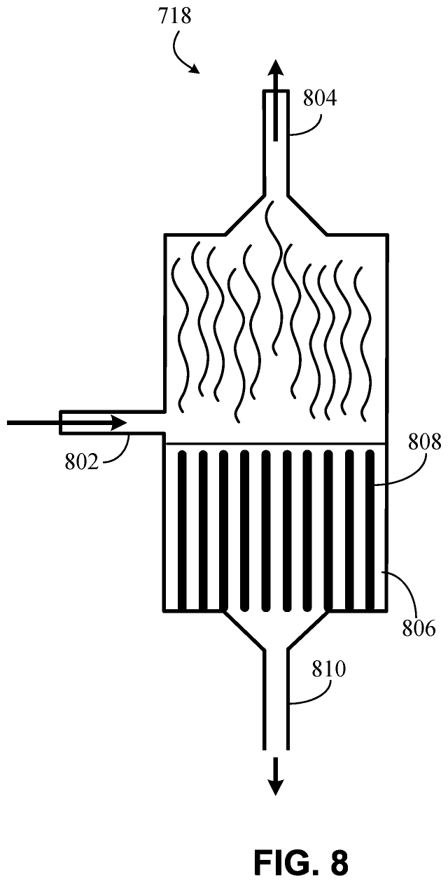

FIG. 8 is a schematic showing heater 718. Stream 716 (C+NiCl₂ (s)) enters heater 718 through inlet 802. Heat is provided to evaporate the solid NiCl₂, which exits heater 718 as NiCl₂ (g) through outlet 804. Downward moving bed of carbon 806 is contacted by heating elements 808 and exits heater 718 by gravity through outlet 810. In some cases, the carbon is contacted with a stripping gas (e.g., a flow HCl at a temperature in a range of about 900° C. to about 1200° C.) near outlet 810 to remove residual NiCl₂ (g) from the carbon. As HCl flows over the mixture, HCl displaces any gaseous NiCl₂ in the solids, such that little or no NiCl₂ is removed along with the solid carbon. The carbon exits heater 718 as homogeneous hollow carbon particles, having a diameter between about 225 nm and about 275 nm (e.g., between about 240 nm and about 260 nm, or about 250 nm).

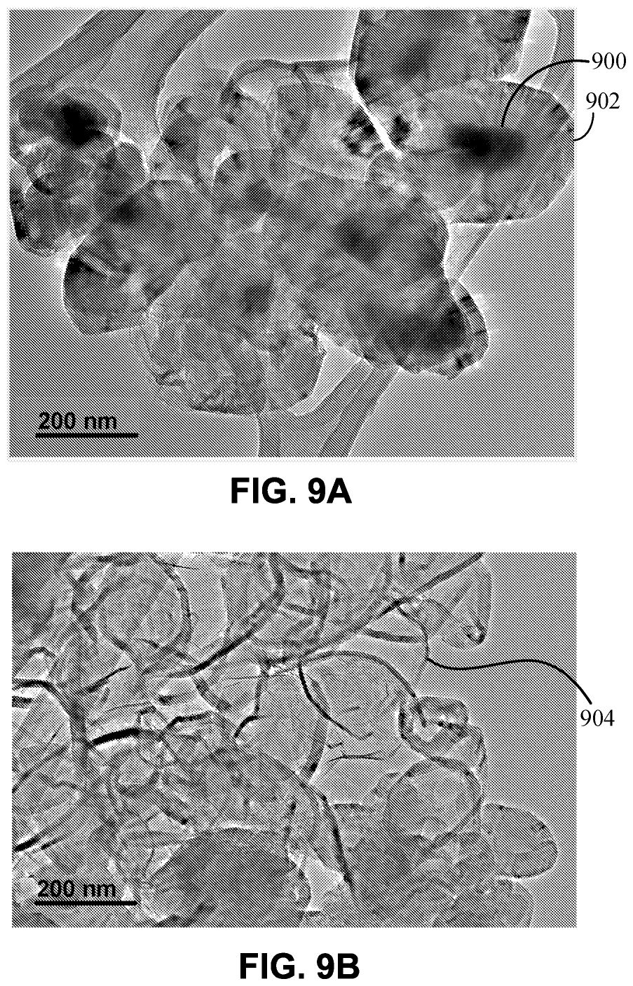

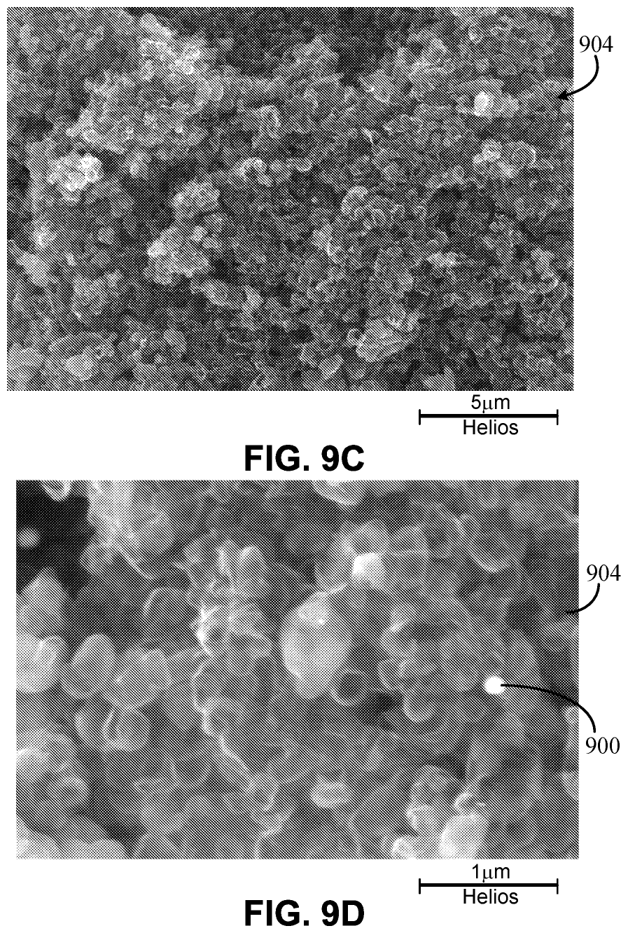

FIG. 9A is a transmission electron micrograph image of nickel particles 900 coated with carbon before regeneration and evaporation of nickel chloride in heater 718. FIG. 9B is a transmission electron micrograph of hollow carbon particles 902 produced after regeneration and evaporation of nickel chloride from the material in FIG. 9A. FIGS. 9C and 9D are scanning electron microscope micrographs at 10,000× and 50,000×, respectively, of hollow carbon particles 902 (with nickel particle 904) produced after regeneration and evaporation of nickel chloride from the material in FIG. 9A. Elemental analysis shows the total metals content of the carbon to be less than 100 ppm. A Toxicity Characteristic Leaching Procedure (TCLP) test shows less than 300 ppb leachable nickel.

In some implementations, components in system 700 (e.g., heaters, heat exchangers, filters) and be repositioned or removed. Other components may be added. One or more streams in system 700 can combined, removed rerouted. Operating parameters may be altered to achieve desired results, such as percentage conversion to hydrogen, purity of streams, and the like.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A reaction method comprising:
subliming a metal salt comprising a metal and a halide to yield a gas phase metal salt comprising the metal and the halide; and
contacting the gas phase metal salt with a gas phase hydrocarbon to yield the metal in elemental form, carbon in elemental form, hydrogen gas, and a hydrogen halide comprising the halide.

2. The method of claim 1, wherein the contacting occurs at a temperature in a range between about 800° C. and about 1300° C. or between about 850° C. and about 1300° C.

3. The method of claim 1, wherein the metal comprises one or more of magnesium, calcium, manganese, iron, cobalt, nickel, and copper.

4. The method of claim 1, wherein the halide comprises one or more of fluoride, chloride, bromide, and iodide.

5. The method of claim 1, wherein the gas phase hydrocarbon comprises natural gas.

6. The method of claim 1, wherein the gas phase hydrocarbon comprises one or more of methane, ethane, propane, butane, pentane, hexane, heptane, octane, and nonane or any isomer thereof.

7. The method of claim 1, wherein the subliming occurs at a pressure in a range between about 0.1 bar and about 50 bar.

8. The method of claim 1, wherein the contacting occurs at a pressure in a range between about 0.1 bar and about 50 bar.

9. The method of claim 1, further comprising pyrolyzing the gas phase hydrocarbon to yield the carbon and the hydrogen gas.

10. The method of claim 9, wherein the contacting comprises reducing the metal in the gas phase metal salt with the gas phase hydrocarbon.

11. The method of claim 9, wherein the pyrolyzing is catalyzed by the metal.

12. The method of claim 9, wherein the heat for the pyrolyzing is provided by electrical power.

13. The method of claim 1, further comprising contacting the metal with the hydrogen halide to yield the metal salt in the gas phase and hydrogen gas.

14. The method of claim 13, further comprising heating the hydrogen halide before contacting the metal with the hydrogen halide.

15. The method of claim 14, wherein heating the hydrogen halide comprises heating the hydrogen halide to a temperature of at least 1000° C.

16. The method of claim 14, wherein contacting the metal with the hot hydrogen halide to yield the metal salt occurs in an adiabatic reactor.

17. The method of claim 13, further comprising condensing the metal salt to yield the metal salt in the solid phase.

18. The method of claim 17, wherein the metal salt in the solid phase is in the form of particles, and the particles are at least partially coated with the carbon.

19. The method of claim 18, further comprising contacting the metal salt with hydrogen chloride having a temperature of at least 1000° C. to yield the metal halide in the gas phase and a particulate carbon material.

20. The method of claim 19, wherein the particulate carbon material comprises a multiplicity of hollow carbon particles.

21. The method of claim 20, wherein the hollow carbon particles have a diameter in a range of about 200 nm to about 300 nm.

22. The method of claim 21, wherein the particulate carbon material comprises less than 100 parts per million by weight of the metal.

23. The method of claim 1, wherein the halide is chloride and the metal is nickel.

24. The method of claim 1, wherein the hydrocarbon comprises methane.

25. The method of claim 1, wherein the subliming occurs prior to the contacting.

26. The method of claim 1, wherein the subliming comprises advancing the metal salt toward a reaction zone of a reactor with the gas phase hydrocarbon.

27. The method of claim 26, further comprising heating the reaction zone to a temperature in range between about 800° C. and about 1300° C.

28. The method of claim 27, wherein heating the reaction zone is achieved with electrical power.

29. The method of claim 28, wherein the electrical power is used to generate radiant heat.

30. The method of claim 29, wherein the radiant heat is provided by an electric furnace or inductive heating elements.

31. The method of claim 1, wherein the subliming and the contacting occur simultaneously in the reaction zone of the reactor.

32. The method of claim 1, wherein the metal salt is anhydrous.

33. A method of generating hydrogen gas, the method comprising:
contacting a metal halide in the gas phase with a hydrocarbon in the gas phase;
decomposing the metal halide and the hydrocarbon to yield a gaseous product comprising hydrogen and hydrogen halide and a solid product comprising metal and carbon;
separating the hydrogen from the hydrogen halide; and
contacting the hydrogen halide with the metal to yield the metal halide in the gas phase.

34. The method of claim 33, further comprising, after contacting the hydrogen halide with the metal, cooling the metal halide in the gas phase to yield the metal halide in the solid phase.

35. The method of claim 34, further comprising heating the metal halide in the solid phase to yield the metal halide in the gas phase.

36. The method of claim 35, further comprising contacting the metal halide in the gas phase with the hydrocarbon in the gas phase.

37. The method of claim 33, further comprising separating the gaseous product from the solid product.

38. The method of claim 33, further comprising, before contacting the hydrogen halide with the metal, heating the hydrogen halide to a temperature of at least about 1000° C.

39. The method of claim 33, further comprising contacting the solid product with the hydrogen halide to yield the metal halide in the gas phase and the carbon.

40. The method of claim 39, further comprising condensing the metal halide to yield a solid mixture comprising metal halide and the carbon.

41. The method of claim 40, wherein the solid mixture comprised particles of the metal halide coated with some of the carbon

42. The method of claim 41, further comprising contacting the solid mixture with hydrogen chloride having a temperature of at least 1000° C. to yield the metal halide in the gas phase and a particulate carbon material.

43. The method of claim 42, wherein the particulate carbon material comprises a multiplicity of hollow carbon particles.

44. The method of claim 43, wherein the hollow carbon particles have a diameter in a range of about 200 nm to about 300 nm.

45. The method of claim 44, wherein the particulate carbon material comprises less than 100 parts per million by weight of the metal.

46. A hydrogen production system comprising:
a first reactor configured react gaseous reactants;
a heat exchanger configured to receive a mixture of gaseous and solid reaction products from the first reactor;
a separator configured to receive a gaseous output from the heat exchanger and to provide a gaseous input to the heat exchanger;
a second reactor configured to react a solid input and a gaseous input from the heat exchanger;
a cooler configured to condense a reaction product from the second reactor;
a third reactor configured to receive a solid product from the cooler, evaporate the solid product to yield a gaseous product, and provide the gaseous product to the first reactor.

47. The system of claim 46, wherein the first reactor, the second reactor, or both are configured to operate at a temperature in a range between about 800° C. and about 1200° C.

48. The system of claim 46, wherein the second reactor is an adiabatic reactor.

49. The system of claim 46, wherein the third reactor is configured to separate components of the solid product from the cooler.

50. The system of claim 46, further comprising an additional separator configured to remove hydrogen from the gaseous input from the heat exchanger.
